(19) United States
(12) Patent Application Publication
(10) Pub. No.: US 2022/0197001 A1
(43) Pub. Date: Jun. 23, 2022

(54) PORTABLE ZOOM MICROSCOPE

(71) Applicant: Huaichang JIA, (US)

(72) Inventor: Runjuan YUAN, Zhongshan (CN)

(21) Appl. No.: 17/170,798

(22) Filed: Feb. 8, 2021

(30) Foreign Application Priority Data
Dec. 17, 2020 (CN) 202023053451.1

(51) Int. Cl. G02B 21/00; G02B 15/14; G02B 21/02; G02B 25/00

(52) U.S. Cl. CPC G02B 21/0008; G02B 15/1421; G02B 25/001; G02B 21/025; G02B 15/1425

(57) ABSTRACT

The present invention discloses a portable zoom microscope, comprising a case (15) and an optical system assembly installed in the case (15), characterized in that the optical system assembly comprises an objective I (1), an objective II (2), an eyepiece III (3), an eyepiece II (4) and an eyepiece I (5) arranged in sequence along an optical axis Z from an object plane to eyes, wherein the objective I (1) is a positive lens, the objective II (2) is a negative lens, the eyepiece III (3) is a positive lens, the eyepiece II (4) is a positive lens, and the eyepiece I (5) is a negative lens, which effectively eliminates the longitudinal chromatic aberration and the lateral colour, so that the zoom microscope can distinguish the details of small objects more clearly and intuitively, greatly improving the image quality of products.

### BACKGROUND OF THE PRESENT INVENTION

### Field of Invention

The present invention relates to a portable zoom microscope.

### Description of Related Arts

The portable zoom microscope commercially available in the market has an optical system which is generally designed with three lenses, as shown in FIG. 1 and FIG. 2, i.e. Objective I A, Zoom eyepiece II B and Eyepiece III C respectively. The Zoom eyepiece II B moves back and forth along the optical axis to realize a zoom function.

The structure above has the following technical problems: 1) the longitudinal chromatic aberration (also known as axial colour) is not effectively eliminated, which causes the polychromatic light of different wavelengths in the areas of the field of view not to coincide, affecting the clarity of images and the resolution of details; 2) the lateral colour is not effectively eliminated, which causes the polychromatic light of different wavelengths in the areas of the off-axis field of view not to coincide, affecting the clarity of images and the resolution of details; moreover, the field of view has colored edges, which affect the observation effect. The ultimate purpose of a microscope is to distinguish the details of small objects. Since the longitudinal chromatic aberration and the lateral colour are not eliminated, the details of small objects are blurred and cannot be distinguished, which ultimately affects the image quality of products.

### SUMMARY OF THE PRESENT INVENTION

The purpose of the present invention is to provide a portable zoom microscope to solve the problem, in the description of the related art, that since the longitudinal chromatic aberration and the lateral colour are not eliminated, the details of small objects are blurred and cannot be distinguished, which ultimately affects the image quality of products.

To fulfill the purpose above, the present invention adopts the follow technical solution:

A portable zoom microscope comprises a case and an optical system assembly installed in the case, and is characterized in that the optical system assembly comprises an objective I, an objective II, an eyepiece III, an eyepiece II and an eyepiece I arranged in sequence along an optical axis Z from an object plane to eyes, wherein the objective I and the objective II are a combination of a positive lens and a negative lens, that is, when the objective I is a positive lens, the objective II is a negative lens, or when the objective I is a negative lens, the objective II is a positive lens; and the eyepiece III is a positive lens, the eyepiece II is a positive lens, and the eyepiece I is a negative lens.

The objective I and the objective II are put together to form an objective group, which moves back and forth along the optical axis Z to realize focusing, and the eyepiece III moves back and forth along the optical axis Z to change the magnification.

The focal length f1 of the objective group is in the range of 2 mm-16 mm; the magnification of the objective group is in the range of 1×-30×, and the size of the linear field of view is in the range of 0.2 mm-5 mm.

The overall magnification of the optical system assembly is in the range of 10×-500×, an aperture stop is located between the objective I and the object plane and is close to the objective I, the numerical aperture NA is in the range of 0.05-0.13, and the distance L1 from the object plane to the objective group is in the range of 0.2 mm-20 mm.

The back-and-forth movement distance of the objective group along the optical axis Z is in the range from −2 mm to +2 mm; the back-and-forth movement distance between the eyepiece III and the eyepiece II is 0.2 mm-25 mm.

The eyepiece III, the eyepiece II and the eyepiece I form a zoom eyepiece group, the magnification of the zoom eyepiece group is in the range of 10×-25×, and the focal length of the zoom eyepiece group is in the range from 10 mm to 25 mm.

The distance L2 from the object plane to a highest point A of the central axis of the eyepiece group is fixed, and the distance L2 is in the range of 30 mm-130 mm.

The objective I, the objective II, the eyepiece III, the eyepiece II and the eyepiece I are all made of high polymer plastics, the refractive indexes of the objective I, the objective II, the eyepiece III, the eyepiece II and the eyepiece I are n1, n2, n3, n4 and n5 respectively; the abbe number of the objective I, the objective II, the eyepiece III, the eyepiece II and the eyepiece I is ν1, ν2, ν3, ν4 and ν5 respectively; the materials of the objective I and the objective II meet the following relationships: 1.0<n2/n1<1.4, 0.18<ν2/ν1<1.1; the materials of the eyepiece II and the eyepiece I meet the following relationships: 0.7<n4/n5<1.16, 0.9<ν4/ν5<5.4; the material of the eyepiece III meets the following relationships: 1.43<n3<1.78, 50<ν3<94.6.

The objective I, the objective II, the eyepiece III, the eyepiece II and the eyepiece I are all aspherical lenses, wherein the objective I is a biconvex positive lens, and the objective II is a biconcave negative lens; the eyepiece III is a biconvex positive lens, with a flat side S1 facing the object plane and a convex side S2 facing the eyes; the eyepiece II is a biconvex positive lens; and the eyepiece I is a negative meniscus lens with a concave side S3 facing the object plane and a convex side S4 facing the eyes.

The objective I and the objective II are put together to form an air gap therebetween, and the eyepiece II and the eyepiece I are put together to form an air gap therebetween.

Compared with the prior art, the present invention has the following beneficial effects:

The present invention comprises a case and an optical system assembly installed in the case, and is characterized in that the optical system assembly comprises an objective I, an objective II, an eyepiece III, an eyepiece II and an eyepiece I arranged in sequence along the optical axis Z from the object plane to the eyes, wherein the objective I and the objective II are a combination of a positive lens and a negative lens, that is, when the objective I is a positive lens, the objective II is a negative lens, or when the objective I is a negative lens, the objective II is a positive lens; the eyepiece III is a positive lens, the eyepiece II is a positive lens, and the eyepiece I is a negative lens; by combining the objective I and the objective II, the longitudinal chromatic aberration can be effectively eliminated; by combing the eyepiece II and the eyepiece I, the lateral colour can be effectively eliminated; the magnification is changed by moving the eyepiece III back and forth, so that the zoom microscope can distinguish the details of small objects more clearly and intuitively, greatly improving the image quality of products.

Other advantages of the invention are described in detail in the embodiment part of the specification.

### BRIEF DESCRIPTION OF THE DRAWINGS

FIG. 1 is a schematic diagram of the optical principle of a three-lens zoom microscope commercially available in the market;

FIG. 2 is a schematic diagram of movement of the zoom lens of a three-lens zoom microscope commercially available in the market;

FIG. 3 is a schematic diagram of the optical principle of the present invention;

FIG. 4 is a schematic diagram of the movement process of the zoom lens of the present invention;

FIG. 5 is a stereoscopic view of the present invention;

FIG. 6 is a sectional view of the present invention;

FIG. 7 is an exploded view of the present invention;

FIG. 8 is a diagram of lateral colour of the present invention at the highest magnification;

FIG. 9 is a diagram of lateral colour of a three-lens zoom microscope commercially available in the market at the highest magnification;

FIG. 10 is a diagram of lateral colour of the present invention at the lowest magnification;

FIG. 11 is a diagram of lateral colour of a three-lens zoom microscope commercially available in the market at the lowest magnification;

FIG. 12 is a diagram of longitudinal chromatic aberration of the present invention at the highest magnification;

FIG. 13 is a diagram of longitudinal chromatic aberration of a three-lens zoom microscope commercially available in the market at the highest magnification;

FIG. 14 is a diagram of longitudinal chromatic aberration of the present invention at the lowest magnification;

FIG. 15 is a diagram of longitudinal chromatic aberration of a three-lens zoom microscope commercially available in the market at the lowest magnification;

FIG. 16 is a spot diagram of the present invention at the highest magnification;

FIG. 17 is a spot diagram of a three-lens zoom microscope commercially available in the market at the highest magnification;

FIG. 18 is a spot diagram of the present invention at the lowest magnification;

FIG. 19 is a spot diagram of a three-lens zoom microscope commercially available in the market at the lowest magnification;

FIG. 20 is a Modulation Transfer Function (MTF) graph of the present invention at the highest magnification;

FIG. 21 is a Modulation Transfer Function (MTF) graph of a three-lens zoom microscope commercially available in the market at the highest magnification;

FIG. 22 is a Modulation Transfer Function (MTF) graph of the present invention at the lowest magnification;

FIG. 23 is a Modulation Transfer Function (MTF) graph of a three-lens zoom microscope commercially available in the market enlarged at the lowest magnification.

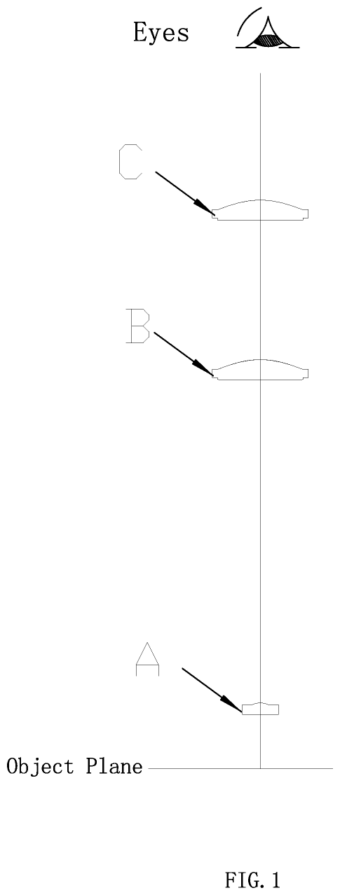

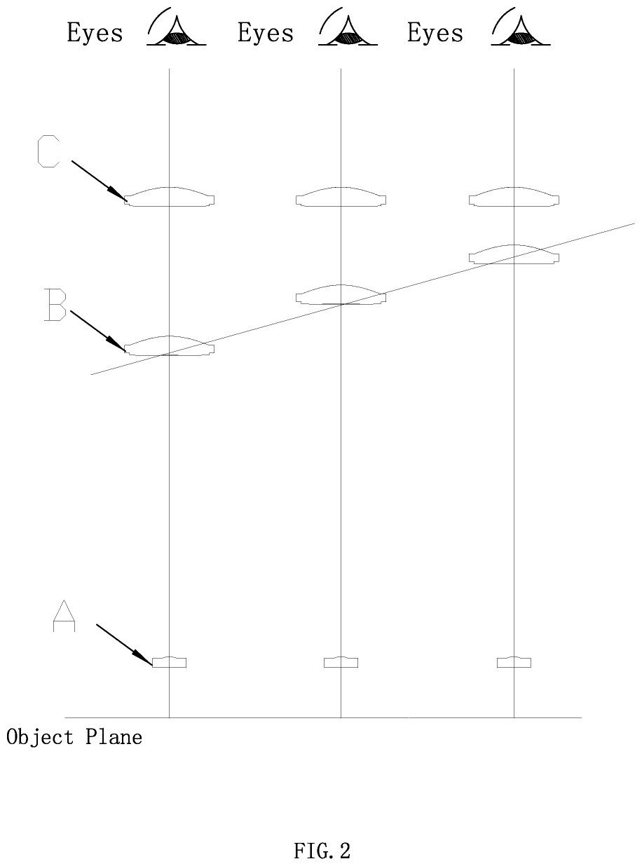

### DETAILED DESCRIPTION OF THE PREFERRED EMBODIMENT

The present invention will be further detailed hereinafter in conjunction with the embodiments and the accompanying drawings.

### Embodiment 1

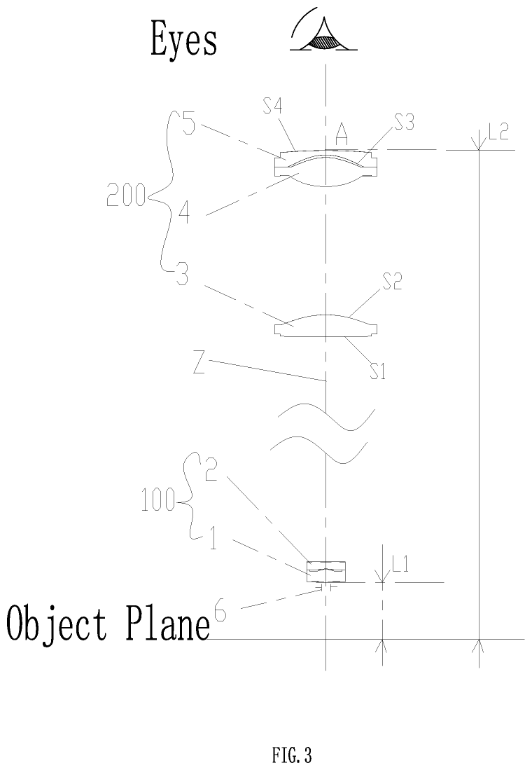

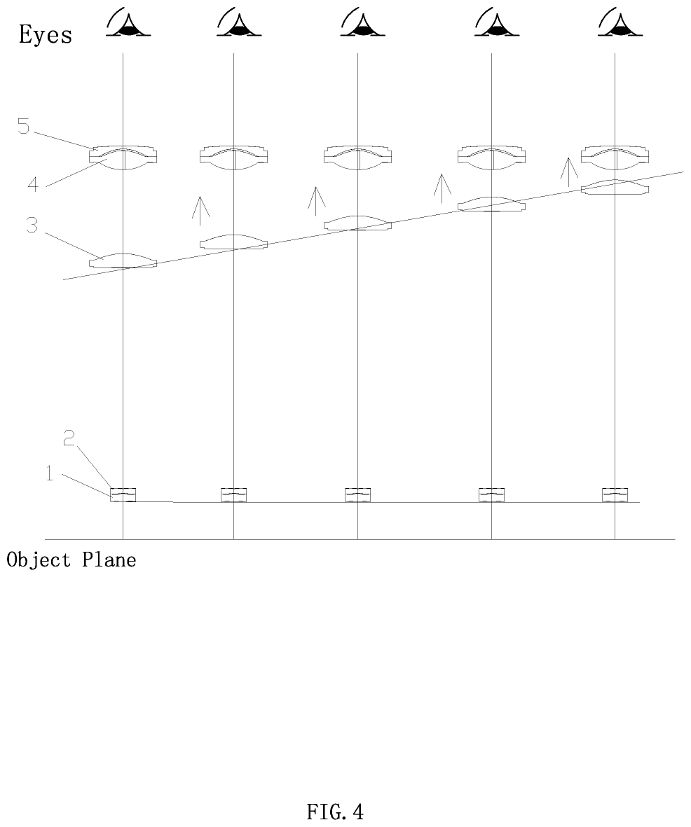

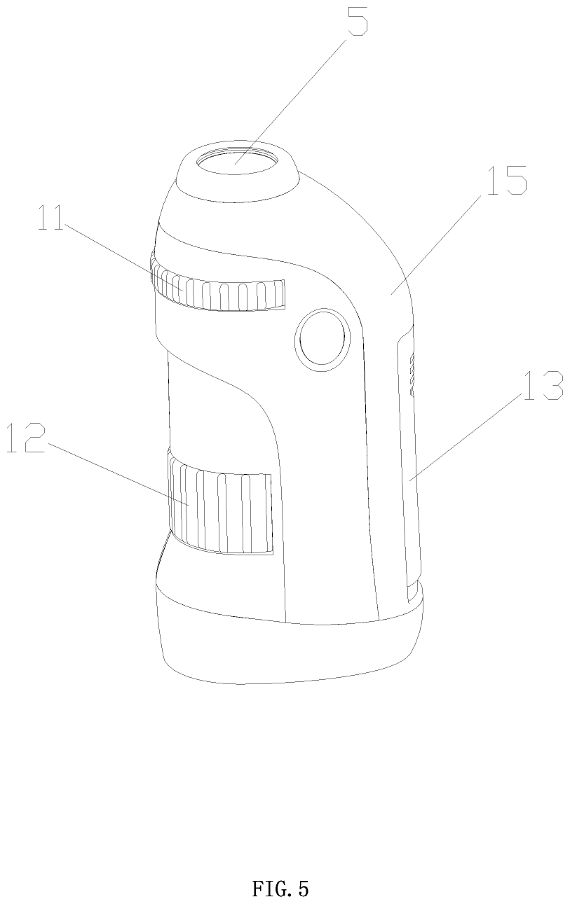

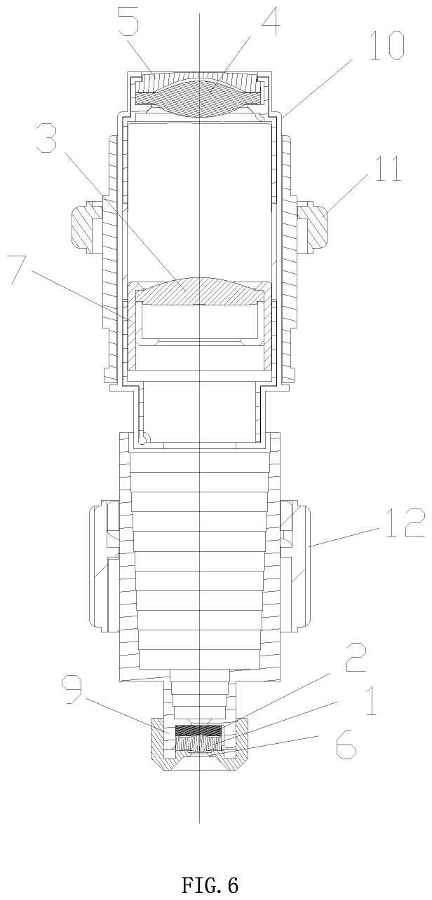

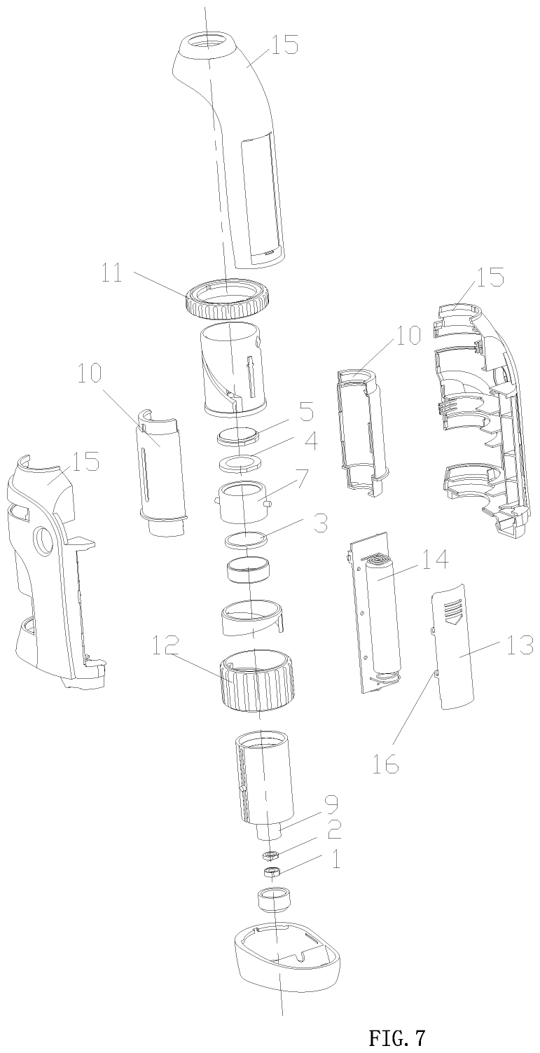

As shown in FIG. 3-7, the present invention is a portable zoom microscope, comprising a case 15 and an optical system assembly installed in the case 15, characterized in that the optical system assembly comprises an objective I 1, an objective II 2, an eyepiece III 3, an eyepiece II 4 and an eyepiece I 5 arranged in sequence along an optical axis Z from an object plane to eyes, wherein the objective I 1 is a positive lens, the objective II 2 is a negative lens, the eyepiece III 3 is a positive lens, the eyepiece II 4 is a positive lens, and the eyepiece I 5 is a negative lens. By combining the objective I 1 and the objective II 2, the longitudinal chromatic aberration can be effectively eliminated; by combining the eyepiece II 4 and the eyepiece I 5, the lateral colour can be effectively eliminated; and the magnification is changed by moving the eyepiece III 3 back and forth, so that the zoom microscope can distinguish the details of small objects more clearly and intuitively, greatly improving the image quality of products.

Of course, the objective I 1 and the objective II 2 are a combination of a positive lens and a negative lens, that is, when the objective I 1 is a positive lens, the objective II 2 is a negative lens, or when the objective I 1 is a negative lens, the objective II 2 is a positive lens. The two methods can also achieve such an effect.

The objective I 1 and the objective II 2 are put together to form an objective group 100 which moves back and forth along the optical axis Z to realize focusing, and the eyepiece III 3 moves back and forth along the optical axis Z to change the magnification, thus providing a simple structure and convenience for manufacturing and use.

The focal length f1 of the objective group 100 is in the range of 2 mm-16 mm; the magnification of the objective group 100 is in the range of 1×-30×, and the size of the linear field of view is in the range of 0.2 mm-5 mm, featuring reasonable parameter design and easy manufacturing.

The outer surface of the case 15 is provided with a zoom adjusting wheel 11 and a focusing wheel 12, wherein the zoom adjusting wheel 11 is located above the focusing wheel 12. When the zoom adjusting wheel 11 is rotated, the eyepiece III 3 moves back and forth along the optical axis Z to change the magnification. When the focusing wheel 12 is rotated, the objective group 100 moves back and forth along the optical axis Z to realize the focusing. The objective I 1 and the objective II 2 are installed in an objective tube 9, the eyepiece III 3 is installed in a zoom movable tube 7, and the eyepiece II 4 and the eyepiece I 5 are installed in the eyepiece tube 10, so that the zoom adjusting wheel 11 drives the transmission mechanism to push the zoom movable tube 7 to move back and forth along the optical axis to realize zooming; and the focusing wheel 12 also drives the transmission mechanism to push the objective tube 9 to move to realize focusing. A battery compartment 14 into which dry batteries are installed is arranged on the right side of the case 15. A cover 13 is arranged at an opening of the battery compartment 14 and is fastened with the case 15 by an L-shaped clip 16, providing a simple and compact structure.

The overall magnification of the optical system assembly is in the range of 10×-500×, an aperture stop 6 is located between the objective I 1 and the object plane and is close to the objective I 1, the numerical aperture NA is in the range of 0.05-0.13, and the distance L1 from the object plane to the objective group 100 is in the range of 0.2 mm-20 mm, featuring reasonable parameter design and easy manufacturing.

The back-and-forth movement distance of the objective group 100 along the optical axis Z is in the range from −2 mm to +2 mm; the back-and-forth movement distance between the eyepiece III 3 and the eyepiece II 4 is 0.2 mm-25 mm, featuring reasonable parameter design and easy manufacturing.

The eyepiece III 3, the eyepiece II 4 and the eyepiece I 5 above form a zoom eyepiece group 200, the magnification of the zoom eyepiece group 200 is in the range of 10 to 25, and the focal length of the zoom eyepiece group 200 is in the range of 10 mm to 25 mm, featuring reasonable parameter design and easy manufacturing.

The distance L2 from the object plane to a highest point A of the central axis of the eyepiece group is fixed, and the distance L2 is in the range of 30 mm-130 mm. In this way, the product height is effectively controlled and the product is easy to carry.

The objective I 1, the objective II 2, the eyepiece III 3, the eyepiece II 4 and the eyepiece I 5 are all made of high polymer plastics, the refractive indexes of the objective I 1, the objective II 2, the eyepiece III 3, the eyepiece II 4 and the eyepiece I 5 are n1, n2, n3, n4 and n5 respectively; the abbe number of the objective I 1, the objective II 2, the eyepiece III 3, the eyepiece II 4 and the eyepiece I 5 is ν1, ν2, ν3, ν4 and ν5 respectively; the materials of the objective I 1 and the objective II 2 meet the following relationships: 1.0<n2/n1<1.4, 0.18<ν2/ν1<1.1; the materials of the eyepiece II 4 and the eyepiece I 5 meet the following relationships: 0.7<n4/n5<1.16, 0.9<ν4/ν5<5.4; the material of the eyepiece III 3 meets the following relationships: 1.43<n3<1.78, 50<ν3<94.6. Materials are easily obtained and the product is convenient to manufacture, which can effectively guarantee the quality of products.

The objective I 1, the objective II 2, the eyepiece III 3, the eyepiece II 4 and the eyepiece I 5 are all aspherical lenses, wherein the objective I 1 is a biconvex positive lens, and the objective II 2 is a biconcave negative lens; the eyepiece III 3 is a biconvex positive lens, with a flat side S1 facing the object plane and a convex side S2 facing the eyes; the eyepiece II 4 is a biconvex positive lens; and the eyepiece I 5 is a negative meniscus lens with a concave side S3 facing the object plane and a convex side S4 facing the eyes. The structure design is reasonable and effectively guarantees the product quality.

The objective I 1 and the objective II 2 are put together to form an air gap therebetween, and the eyepiece II 4 and the eyepiece I 5 are put together to form an air gap therebetween, providing a structure of reasonable design.

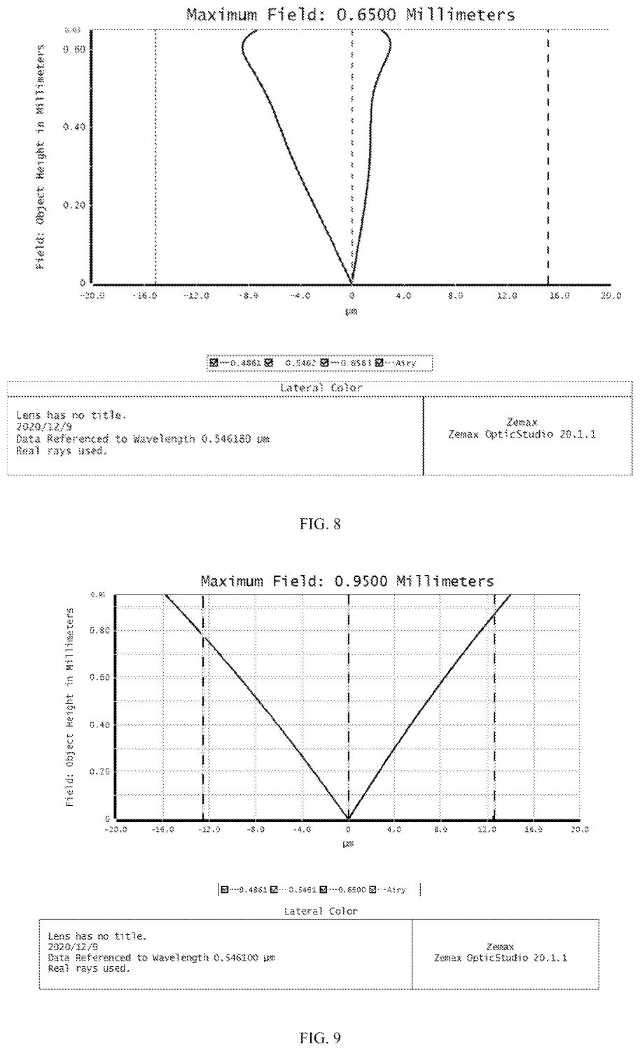

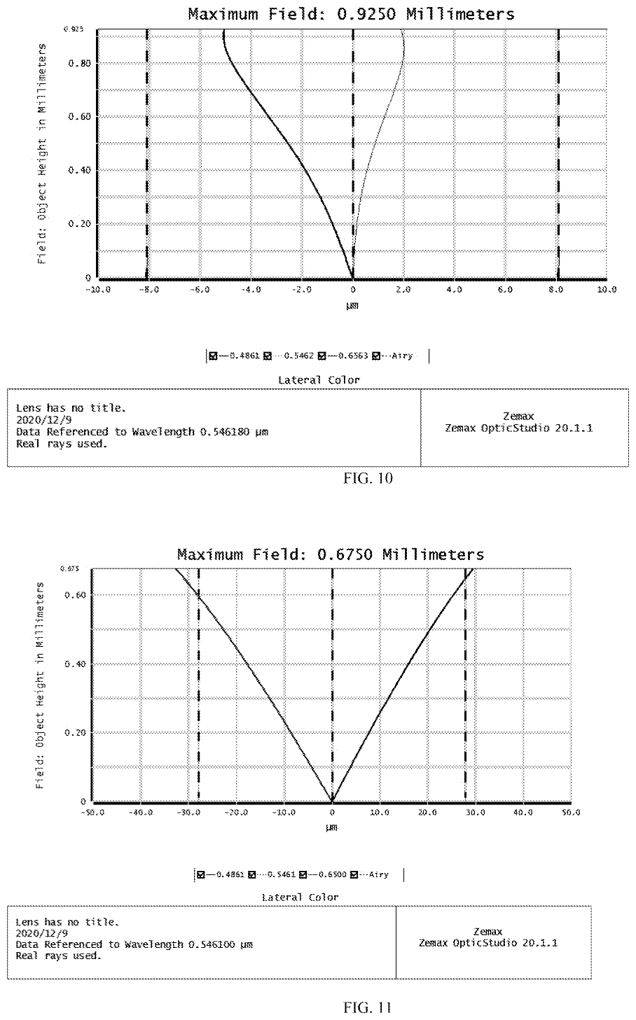

The eyepiece II 4 is a positive lens, and the eyepiece I 5 is a negative lens. The combination of the eyepiece II 4 and the eyepiece I 5 effectively eliminates the lateral colour. As shown in FIG. 8 and FIG. 10, the lateral colour graph of the present invention shows a wider tolerance zone. In FIG. 8, the tolerance zone of the lateral colour graph of the present invention is ±15 μm, and the absolute value is 8 μm at the greatest magnification; in FIG. 9, which shows the state of enlargement at the highest magnification of a three-lens zoom microscope commercially available in the market, the tolerance zone of the lateral colour graph is ±12.5 μm, and the absolute value is 16 μm; the two differ from each other by 1 times in the effect of eliminating the lateral colour; in FIG. 10, the tolerance zone of the lateral colour graph of the present invention is ±8 μm, and the absolute value is 5 μm under the state of enlargement at the lowest magnification; in FIG. 11, which shows the state of enlargement at the lowest magnification of a three-lens zoom microscope commercially available in the market, the tolerance zone of the lateral colour graph is ±28 μm, and the absolute value is 32 μm; the two differ from each other by more than 6 times in the effect of eliminating the lateral colour.

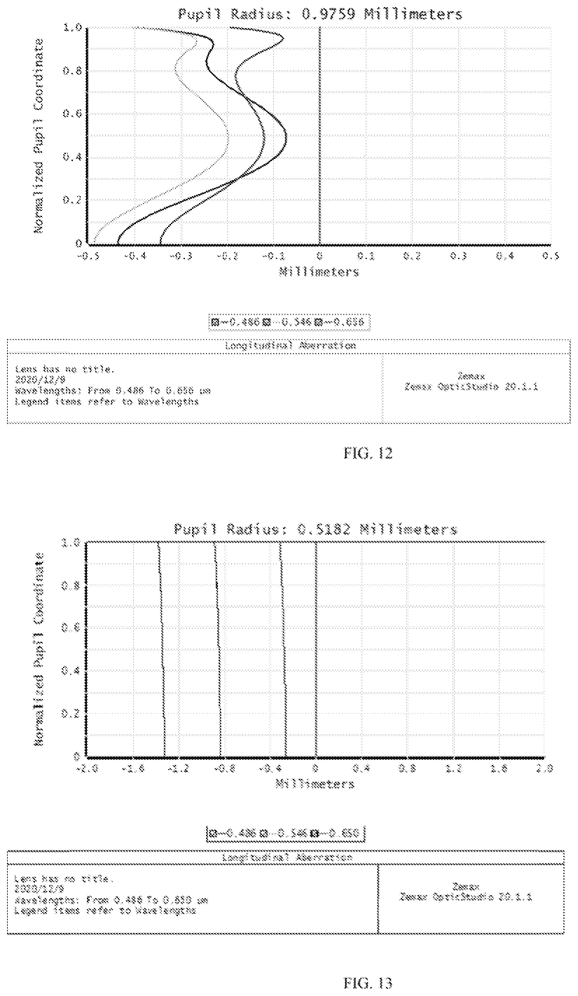

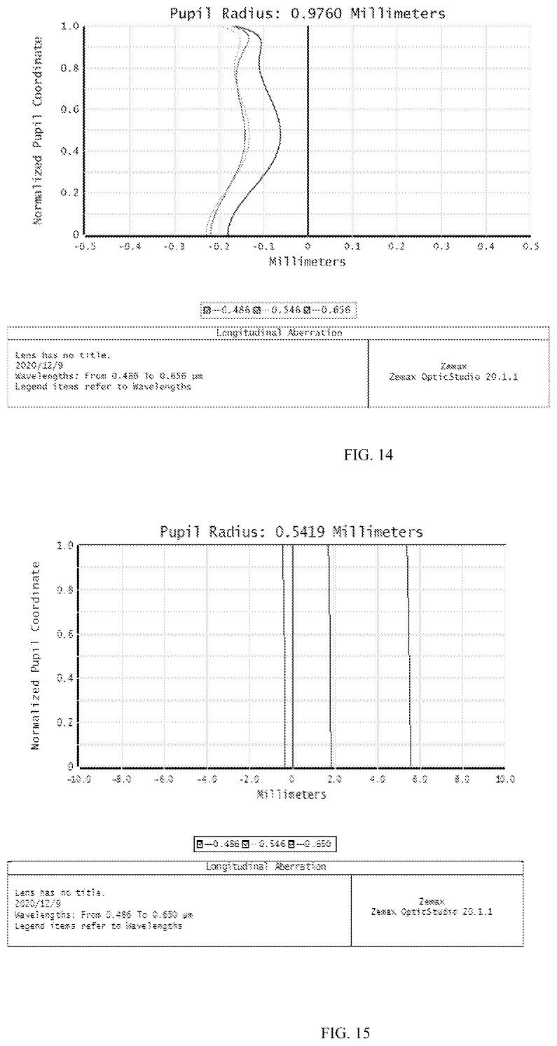

The objective I 1 is a positive lens, and the objective II 2 is a negative lens. The longitudinal chromatic aberration is effectively eliminated by combining the objective I 1 and the objective II 2. In FIG. 12, which shows the state of enlargement at the highest magnification of the present invention, the longitudinal chromatic aberration is 0.14 mm, and the colored light curves of different colors of several wavelengths intersect each other, so the chromatic aberration is eliminated at different angles of field; while in FIG. 13, which shows the state of enlargement at the highest magnification of a three-lens zoom microscope commercially available in the market, the longitudinal chromatic aberration is 1.07 mm, and the colored light curves of different colors of several wavelengths do not intersect, so the chromatic aberration is not eliminated at different angles of field. The two differ from each other by more than 7 times in the effect of eliminating the longitudinal chromatic aberration under the state of enlargement at the highest magnification. In FIG. 14, which shows the state of enlargement at the lowest magnification of the present invention, the longitudinal chromatic aberration is 0.05 mm, and the colored light curves of different colors of several wavelengths intersect each other, so the chromatic aberration is eliminated at different angles of field; while in FIG. 15, which shows the state of enlargement at the lowest magnification of a three-lens zoom microscope commercially available in the market, the longitudinal chromatic aberration is 5.87 mm, and the colored light curves of different colors of several wavelengths do not intersect, so the chromatic aberration is not eliminated at different angles of field. The two differ from each other by more than 100 times in the effect of eliminating the longitudinal chromatic aberration under the state of enlargement at the lowest magnification.

The role of the microscope is to distinguish the details of small objects. If the chromatic aberration (longitudinal chromatic aberration+lateral colour) is not eliminated, the details of small objects will be blurred and cannot be distinguished, which will affect the overall quality. There are two ways to determine how well details are distinguished: comparison of spot diagrams and comparison of Modulation Transfer Function (MTF).

The first method is the comparison method of spot diagrams:

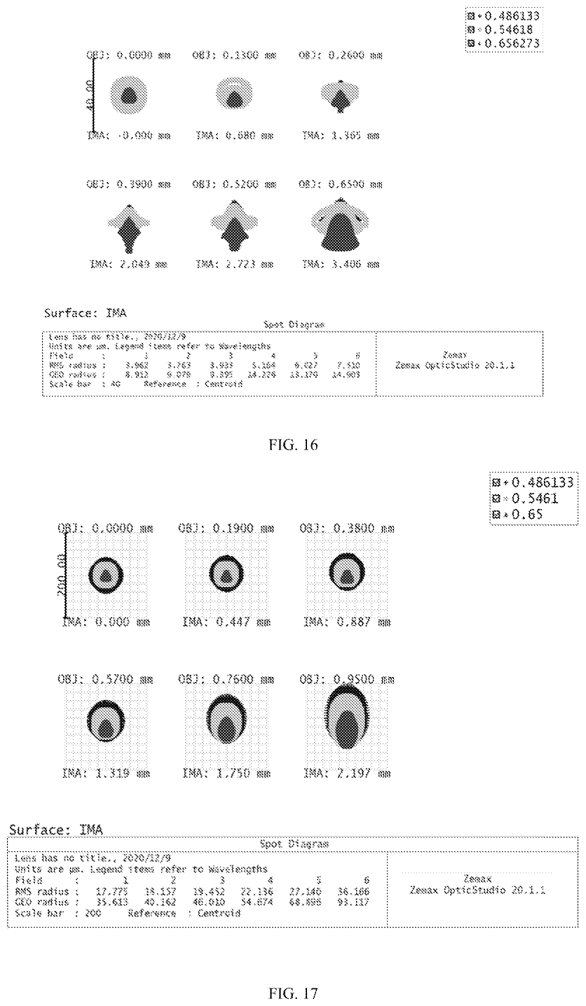

As shown in FIG. 16, the spot diagram of the present invention at the highest magnification, the root mean square radius (RMS point radius for short) of the center is 4 μm, and the RMS point radius of the edge is 7 μm; the geometric point radius of the center is 9 μm, and the geometric point radius of the edge is 15 μm. As shown in FIG. 17, the spot diagram of a three-lens zoom microscope commercially available in the market at the highest magnification, the RMS point radius of the center is 18 μm, and the RMS point radius of the edge is 36 μm; the geometric point radius of the center is 36 μm, and the geometric point radius of the edge is 93 μm. Obviously, under the state of enlargement at the highest magnification, the comparison of spot diagrams shows that the detail resolving power of the present invention for small objects is more than 4 times higher than that of the similar products in the market.

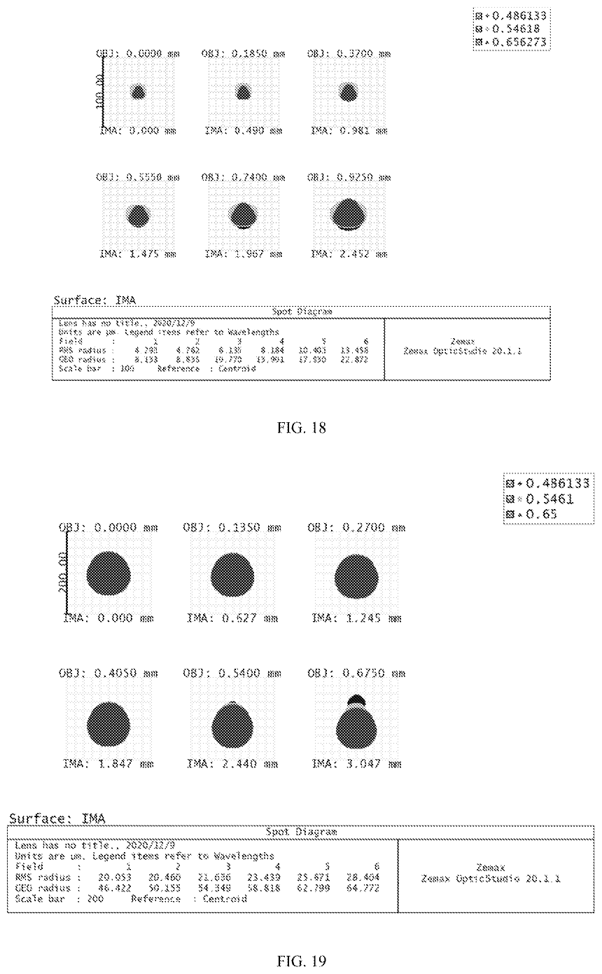

As shown in FIG. 18, the spot diagram of the present invention at the lowest magnification, the root mean square radius (RMS point radius for short) of the center is 4.2 μm, and the RMS point radius of the edge is 13.5 μm; the geometric point radius of the center is 8 μm, and the geometric point radius of the edge is 23 μm. As shown in FIG. 19, the spot diagram of a three-lens zoom microscope commercially available in the market at the lowest magnification, the RMS point radius of the center is 20 μm, and the RMS point radius of the edge is 28 μm; the geometric point radius of the center is 46 μm, and the geometric point radius of the edge is 64 μm. Obviously, under the state of enlargement at the lowest magnification, the comparison of spot diagrams shows that the detail resolving power of the center of the present invention for small objects is around more than 5 times higher than that of the similar products in the market.

The second method is the comparison method of Modulation Transfer Function (MTF):

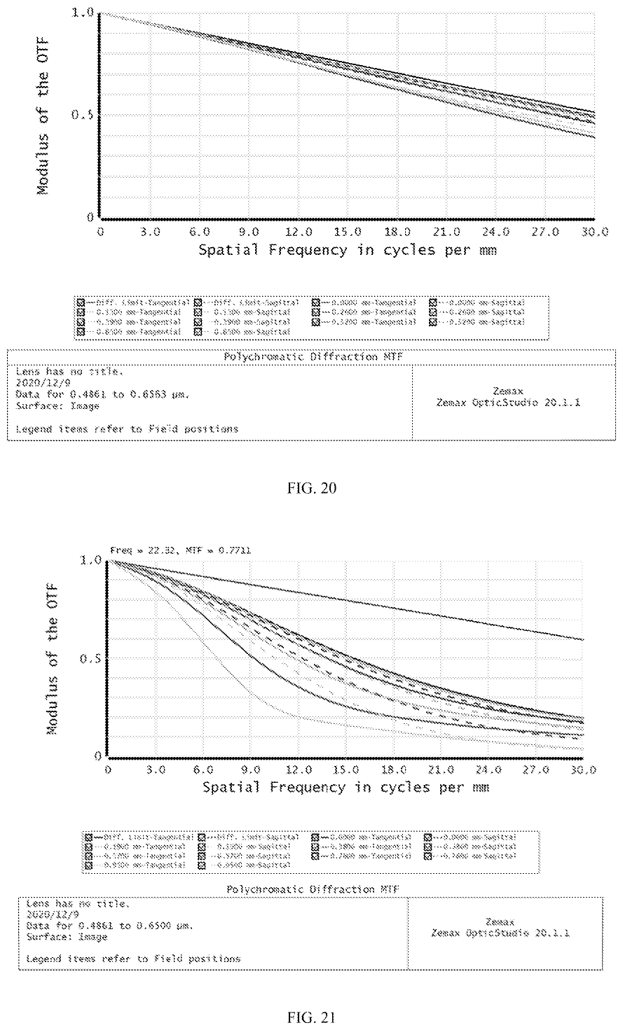

As shown in FIG. 20, the Modulation Transfer Function (MTF) graph of the present invention under the state of enlargement at the highest magnification, the contrast value at Line 30: 30 Lp/mm=0.5. As shown in FIG. 21, the Modulation Transfer Function (MTF) graph of a three-lens zoom microscope commercially available in the market at the highest magnification, the contrast value at Line 30: 30 Lp/mm=0.19. Obviously, u at the highest magnification, the comparison of Modulation Transfer Function (MTF) shows that the detail resolving power of the present invention for small objects is 2.6 times higher than that of the similar products in the market.

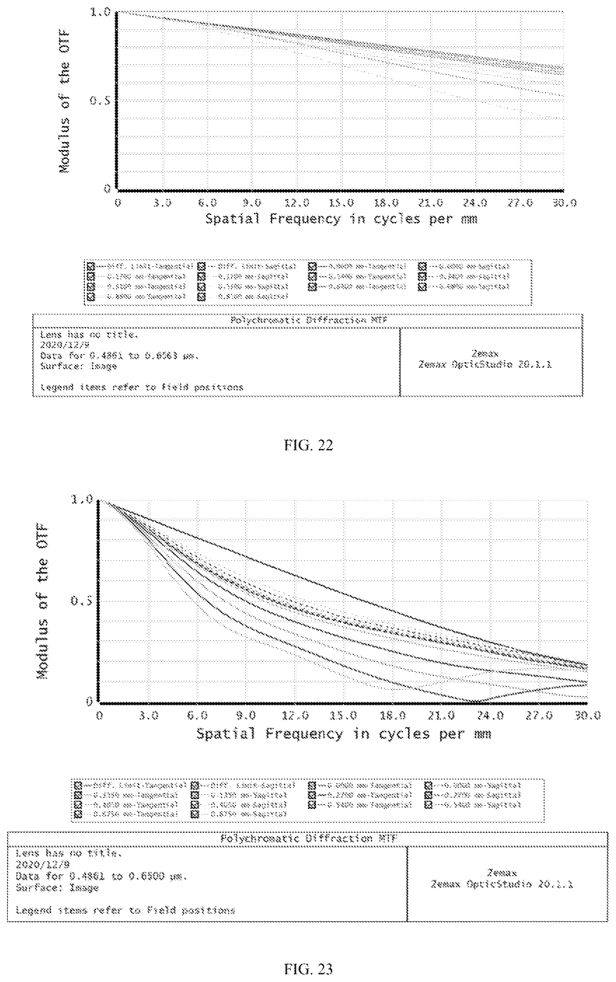

As shown in FIG. 22, the Modulation Transfer Function (MTF) graph of the present invention under the state of enlargement at the lowest magnification, the contrast value at Line 30: 30 Lp/mm=0.39. As shown in FIG. 23, the Modulation Transfer Function (MTF) graph of a three-lens zoom microscope commercially available in the market at the lowest magnification, the contrast value at Line 30: 30 Lp/mm=0.04. Obviously, at the lowest magnification, the comparison of Modulation Transfer Function (MTF)s shows that the detail resolving power of the center of the present invention for small objects is around 9.75 times higher than that of the similar products in the market.

The above embodiment is merely a preferred one of the present invention, and is not intended to limit the present invention. Any other changes, modifications, substitutions, combinations and simplifications obtained without departing from the spiritual essence and principle of the present invention are equivalent replacement methods, which are included in the protection scope of the present invention.

What is claimed is:

1. A portable zoom microscope, comprising a case (15) and an optical system assembly installed in the case (15), characterized in that the optical system assembly comprises an objective I (1), an objective II (2), an eyepiece III (3), an eyepiece II (4) and an eyepiece I (5) arranged in sequence along an optical axis Z from an object plane to eyes, wherein the objective I (1) and the objective II (2) are a combination of a positive lens and a negative lens, that is, when the objective I (1) is a positive lens, the objective II (2) is a negative lens, or when the objective I (1) is a negative lens, the objective II (2) is a positive lens; and the eyepiece III (3) is a positive lens, the eyepiece II (4) is a positive lens, and the eyepiece I (5) is a negative lens.

2. The portable zoom microscope according to claim 1, wherein the objective I (1) and the objective II (2) are put together to form an objective group (100) which moves back and forth along the optical axis Z to realize focusing, and the eyepiece III (3) moves back and forth along the optical axis Z to change the magnification.

3. The portable zoom microscope according to claim 2, wherein a focal length f1 of the objective group (100) is in the range of 2 mm-16 mm; the magnification of the objective group (100) is in the range of 1×-30×, and the size of a linear field of view is in the range of 0.2 mm-5 mm.

4. The portable zoom microscope according to claim 3, wherein the overall magnification of the optical system assembly is in the range of 10×-500×, an aperture stop (6) is located between the objective I (1) and the object plane and is close to the objective I (1), a numerical aperture NA is in the range of 0.05-0.13, and a distance L1 from the object plane to the objective group (100) is in the range of 0.2 mm-20 mm.

5. The portable zoom microscope according to claim 4, wherein the back-and-forth movement distance of the objective group (100) along the optical axis Z is in the range from −2 mm to +2 mm; and the back-and-forth movement distance between the eyepiece III (3) and the eyepiece II (4) is 0.2 mm-25 mm.

6. The portable zoom microscope according to claim 5, wherein the eyepiece III (3), the eyepiece II (4) and the eyepiece I (5) form a stepless zoom eyepiece group (200), a magnification of the stepless zoom eyepiece group (200) is in the range from 10× to 25×, and a focal length of the stepless zoom eyepiece group (200) is in the range from 10 mm to 25 mm.

7. The portable zoom microscope according to claim 6, wherein a distance L2 from the object plane to a highest point A of a central axis of the eyepiece group is fixed, and the distance L2 is in the range of 30 mm-130 mm.

8. The portable zoom microscope according to claim 7, wherein the objective I (1), the objective II (2), the eyepiece III (3), the eyepiece II (4) and the eyepiece I (5) are all made of high polymer plastics, refractive indexes of the objective I (1), the objective II (2), the eyepiece III (3), the eyepiece II (4) and the eyepiece I (5) are n1, n2, n3, n4 and n5 respectively; the abbe number of the objective I (1), the objective II (2), the eyepiece III (3), the eyepiece II (4) and the eyepiece I (5) is ν1, ν2, ν3, ν4 and ν5 respectively; materials of the objective I (1) and the objective II (2) meet the following relationships: 1.0<n2/n1<1.4, 0.18<ν2/ν1<1.1; materials of the eyepiece II (4) and the eyepiece I (5) meet the following relationships: 0.7<n4/n5<1.16, 0.9<ν4/ν5<5.4; a material of the eyepiece III (3) meets the following relationships: 1.43<n3<1.78, 50<ν3<94.6.

9. The portable zoom microscope according to claim 1, wherein the objective I (1), the objective II (2), the eyepiece III (3), the eyepiece II (4) and the eyepiece I (5) are all aspherical lenses, wherein the objective I (1) is a biconvex positive lens, and the objective II (2) is a biconcave negative lens; the eyepiece III (3) is a biconvex positive lens, with a flat side S1 facing the object plane and a convex side S2 facing the eye; the eyepiece II (4) is a biconvex positive lens; and the eyepiece I (5) is a negative meniscus lens with a concave side S3 facing the object plane and a convex side S4 facing the eye.

10. The portable zoom microscope according to claim 9, wherein the objective I (1) and the objective II (2) are put together to form an air gap therebetween, and the eyepiece II (4) and the eyepiece I (5) are put together to form an air gap therebetween.
